(19) United States
(12) Patent Application Publication
(10) Pub. No.: US 2002/0010668 A1
(43) Pub. Date: Jan. 24, 2002

(54) Online merchandising and marketing system

(76) Inventors: Roger M. Travis, Cambridge, MA (US); Jean Cloutier, Toronto (CA)

Correspondence Address: Elizabeth E. Nugent, Choate, Hall & Stewart, 53 State Street, Boston, MA, 02109, US

(21) Appl. No.: 09/770,905

(22) Filed: Jan. 26, 2001

Related U.S. Application Data
(60) Provisional application No. 60/178,505, filed on Jan. 27, 2000.

(51) Int. Cl. G06F 17/60

(52) U.S. Cl. 705/35

(57) ABSTRACT

An online targeted merchandising system that allows a user to purchase an entire experience, including commodities from a plurality of vendors, in a single online transaction. The system may include means for dynamically adjusting offerings, and for selecting which of several offerings to present to a particular user.

This application claims benefit of priority to U.S. Provisional Application No. 60/178,505, filed Jan. 27, 2000, which is incorporated herein by reference.

### FIELD OF THE INVENTION

The present invention relates to a computer-based system for allowing groups of retailers to provide a commonly themed shopping experience. In particular, the invention relates to a dynamically adjustable third party system that allows merchandisers to offer a single experiential product comprising components from different vendors.

### BACKGROUND OF THE INVENTION

Online merchandisers typically are either brand owners (e.g., Williams-Sonoma™, L.L. Bean™) who market their own products, or semi-comprehensive vendors of products of a particular type, such as books or popular music (e.g., BarnesandNoble.com™, CDNow.com™). A large class of shoppers, on the other hand, frequently are not seeking items of a particular brand or class, but are seeking products related to a particular life experience, such as taking a vacation, planning a wedding, or starting a family. Traditional on-line marketing systems do not provide comprehensive services to such shoppers, who must identify the products they need individually and seek each one out separately. The present invention seeks to remedy this lack by providing a system where online merchandisers may collectively present related products, while maintaining their own customer lists and other proprietary data secure from one another.

### SUMMARY OF THE INVENTION

Our invention includes methods to automatically construct aggregated product offerings according to a set of predetermined rules established by individual coparticipating brand owners for acceptable placement. Other methods are provided for automatically evaluating and reporting the relative economic effects of one product brand upon another in an aggregated online shopping offering. The aggregated online product offers may be optimized to maximize sales and related benefits by continuous measurement of consumer response to offers and by continuous replacement of products with alternates to determine the highest performing combinations.

Our invention further comprises methods to increase sales effectiveness by creating overall online shopping experiences. The shopping experiences comprise aggregations of products whose composition and arrangement may be derived from consumer research on consumer satisfaction with different combinations of products. The experience may comprise sales offers from multiple product brands that are all focused on a single buying intention, which may be derived, for example, from a significant life experience such as planning a vacation or a wedding. The invention further comprises methods of identifying consumers who are likely to buy specific products and attracting them to the aggregated online shopping experience.

In addition, our invention comprises methods of creating virtual databases of consumer information which use information stored in separate remote databases, without sharing actual consumer name and address information between the owners of the separate remote databases.

As used herein, “online shopping” and “eCommerce” refer to shopping experiences which may be carried out via the Internet, or via kiosks, televisions equipped with digital information transmission, automated telephone services, personal digital assistants with communications capabilities, or other automated interactive systems. While the shopping experiences described herein are illustrated with the use of static images, the invention also comprises the use of video, audio, and other dynamic objects which may further comprise “hot links” or other interactive components in creating the overall shopping experience.

### BRIEF DESCRIPTION OF THE DRAWING

The invention is described with reference to the several figures of the drawing, in which,

FIG. 1 is an invitation to participate in an online shopping experience according to the invention; and

FIG. 2 is a gateway to the online shopping experience.

### DETAILED DESCRIPTION

The present invention provides an online system and method for marketing groups of products. Presented groups of brands and products may be attractive to consumers as part of a particular life-stage experience (e.g., choosing a school, going away to college, getting a job, buying a home, getting married, having a baby, building a career, building a lifestyle, starting a business, organizing a family reunion, or caring for elderly or ill relatives), or because they relate to an experience associated with a particular lifestyle (e.g., taking a vacation, decorating a home, hosting a party, continuing education, planning a holiday, giving gifts, eating out, or planning entertainment). Experience-related offerings may be presented to a particular user when that user's online activity suggests that the user may match a particular predetermined user archetype. Archetype-matching activity may be simple (e.g., an online bookstore search containing the word “wedding” may trigger the presentation of an invitation to shop for wedding-related products), or more complex (e.g., willingness to purchase relatively expensive items online, combined with interest in the books of Jack London and Ernest Hemingway, might trigger the presentation of an invitation to shop for elements of an outdoor vacation experience).

The process of classifying users into archetypes, and selecting presentations for different archetypes, is referred to herein as Customer Experience Modeling™ (CEM). While the preferred embodiment of the invention described herein focuses on merchandising systems for experiences comprising components from multiple vendors, CEM may also be used to select and refine a package of products and services within a brand (e.g., in selecting banking services and products to present to a user). Those skilled in the art will readily see how CEM principles may be expanded to cover these intrabrand marketing opportunities.

Research suggests that many consumers would prefer to purchase “experiences,” rather than products (see, e.g., Pine and Gilmore, “Welcome to the Experience Economy,” Harvard Business Review, July/August 1998, pp. 97-105, which is incorporated herein by reference). Experiential marketing makes the shopping experience itself more pleasurable, and also provides convenience to the shopper. The present invention allows busy shoppers to purchase whole experiences in a single transaction, instead of buying many commoditized parts from different vendors.

The CEM methodology assumes that most individual product purchases are part of a broader buying intention. Buying a new chair may be part of redecorating a house. Buying a plane ticket is often associated with a host of other purchases such as hotels, rental cars, books, insurance, and baby sitters. Similarly, every restaurant reservation, theater ticket, article of clothing, and bank product sold may potentially be part of a series of actions or purchases that the consumer plans to make to fulfill his intentions.

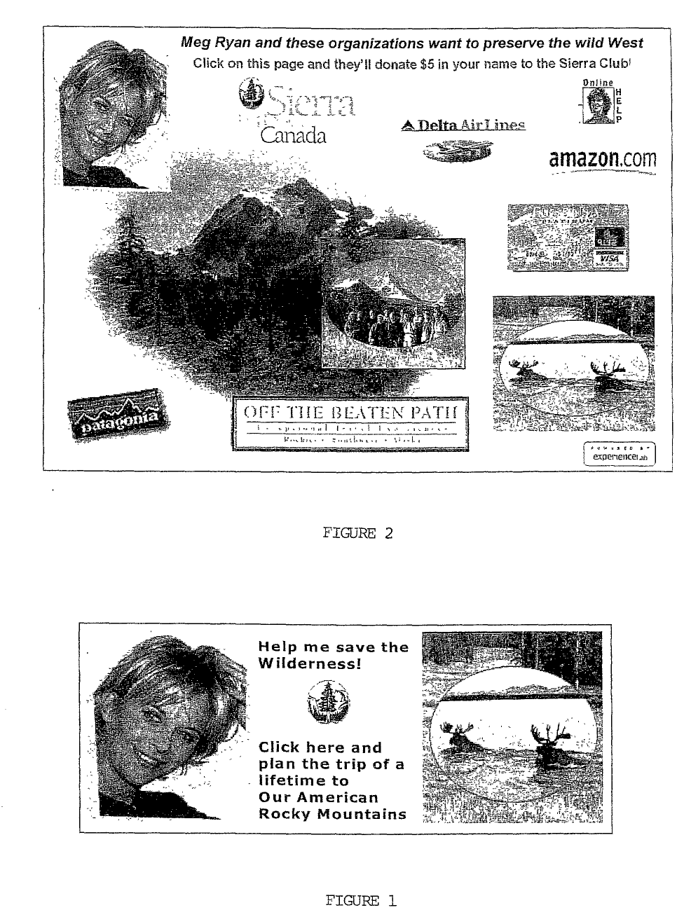

According to the invention, a user is presented with an invitation to shop for a particular experience, for example in the form of a banner ad. An example of an invitation to shop for an adventure travel experience is shown in FIG. 1. The selection of whether to display the invitation to a particular, and of which invitation to display, may be based on whether the user's profile matches a predefined archetype defined using a CEM approach. For invitations to themed experiences such as that shown in FIG. 1, the archetype is determined to represent people likely to be interested in participating in the experience, as further discussed below. Typically the invitation will be displayed to the user from within the web site of one of the vendors of the commodities associated with the experience, maintaining the “look and feel” of the vendor web site, although the user may also be taken directly to a central web site associated with the merchandising system.

If the user accepts the invitation to shop for the experience, for example by clicking on the banner ad shown in FIG. 1, he is taken to a collection of brand icons, shown in FIG. 2, where he can begin shopping. As shown, the icons may include “brands” that are not vendors per se, but appear in order to enhance the consumer perception over the overall experience, e.g., Meg Ryan and the Sierra Club. The mix of icons is selected to appeal to the particular customer archetype, and may be varied based on available information about the user. If the user clicks to continue the shopping experience, he is presented with a set of products that will make up the experience, which might include the adventure travel package itself (in the example shown, from the adventure travel company Off The Beaten Path), air tickets to the point of departure, and appropriate clothing and books to prepare him for the trip. Each of these items may be customizable via a planning “wizard”, but by default, the user is presented with a package of products that appear to be appropriate for his archetype. These products are placed in a combined virtual shopping cart, and may be purchased in a single transaction.

In order to accomplish these functions, the server that presents the shopping experience must access the web ordering systems of the suppliers, to confirm price and availability. In preferred embodiments of the invention, the user may at any time access a call service providing live customer service by email, telephone, or videoconference. The call service may be able to provide additional information about the experience directly, or may transfer or conference in a support person from an individual vendor in order to address particular customer concerns.

Development of a targeted web offering according to the CEM methodology begins with identifying target market segments and buying intentions. Traditional marketing means, such as secondary market research, web surveys, and focus groups may be used to select a target market and a life-stage or lifestyle experience with an associated buying intention. Microsegmentation studies may then be used to define fine grain targets. Once a target market and intention have been selected, demographic profiling of members of the target market having the selected buying intention may be used to determine scoring variables, which will be used to classify consumers into archetypes. The scoring variables will preferably be related to data that may readily be collected online by the participating vendors in the merchandising system, such as buying patterns, “wish list” or registry items, and searches performed at the participating sites. Data such as surveys about the buying experience may also be used to score consumers, as well as to refine the scoring variable system. The components of the experience that will be sold to satisfy the buying intentions are then selected. The most basic components of the experience may be readily identifiable (e.g., a tour package and an airline ticket for a vacation experience), but other components (e.g., tour books and appropriate clothing) may need to be identified via brainstorming sessions and focus group analysis. Cluster analysis may also be used to refine the selection of components. In addition, participating merchandisers are identified; these are preferably well-known companies that consumers already identify with quality experiences. Merchandisers should preferably also have in place sophisticated web ordering and tracking systems that may be queried by the central system in order to adjust and place orders for experiences.

In parallel with selecting the merchandisers and components of the experience, attractive invitations to participate in the experience must be developed. Again, focus groups are useful for determining which collections of brands and sales designs attract the highest traffic. The invitations to participate in the experience may be tailored to subgroups with similar buying intentions but different preferences. In a simple example, the endorsement of Meg Ryan in FIGS. 1 and 2 could be replaced with one from Robert Redford for female buyers.

Elements of the design and components of the experience can be readily adjusted during the course of an offering. Different endorsing celebrities, different artwork, and different product mixes may be offered in order to experimentally determine which produces the greatest sales. Automated choice modeling, as described above, allows different options to be presented to different consumers in a targeted way once experimental results and/or focus group preferences are determined. Follow-up surveys, interviews, and focus groups may be used to determine satisfaction with the overall purchasing process and with the purchased experience, in order to further refine future offerings.

Once differentiated offerings have been developed, the merchandising system preferably can select among them the most appropriate offering for a particular user. In preferred embodiments of the invention, the merchandising system comprises a central database of user information collected at the vendor sites. Each vendor site maintains its own data on purchases, and possibly also on products viewed and searches performed. This data is shared with the central database, either on an ongoing basis or as a supplement to a request to serve a banner advertisement to the user. Typically vendor sites maintain records of user activity by placing a “cookie” on the user's computer, which allows the user to be identified in subsequent visits. The central database comprises information uploaded from each individual merchandiser, as well as information entered by users during the process of making a purchase. This information is preferably accessible only to vendors on a “need to know” basis—for example, when an order must be filled by the vendor, who then needs shipping information. If the vendor simply needs to serve an invitation to participate in a shopping experience to the customer, the central database need only return the invitation (or an indication of which locally stored invitation to use).

Preferably, the central database is able to correlate data pertaining to the same user uploaded by different vendors, in order to obtain a more complete picture of user preferences. This may be done “by hand,” by comparing user names and other identifying data, or by automated comparisons of identifying data.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A targeted online marketing and merchandising system for merchandising a collection of products from different merchandisers each maintaining a purchaser information database, comprising:
a central database of purchasing information relating to users;
means for serving a user a collection of related brand symbols, each symbol associated with a merchandiser;
means for serving the user a product description in response to selection of one of the related brand symbols; and
means to allow the user to purchase products from a plurality of the merchandisers in a single transaction,
wherein no merchandiser may access another merchandiser's purchaser information database, but each merchandiser may upload information relating to users to the central database.

2. The system of claim 1, wherein information stored in the central database includes one or more customer information items selected from the group consisting of demographic profile, psychographic profile, age, name, shipping address, billing address, past purchases, consumer archetype, reactions to previous advertising, web visit behavior, and product preferences.

3. The system of claim 1, wherein the system is implemented on a central computer server, which stores the central database and serves collections of related brand symbols and product descriptions over the Internet.

4. The system of claim 1, wherein the means to allow the user to select the brand symbol and to purchase the products comprise a server that receives customer orders over the Internet.

5. The system of claim 1, wherein the means to allow the user to purchase the products comprise a telephone order fulfillment system.

6. The system of claim 1, wherein the means for serving the collection of related brand symbols comprises means for selecting a set of brand symbols to be served based on information relating to the user stored in the central database.
